(19) United States
(12) Patent Application Publication
(10) Pub. No.: US 2015/0235509 A1
(43) Pub. Date: Aug. 20, 2015

(54) Slot Game with Credit Redistribution

(71) Applicant: Fernando DiCarlo, Woodbridge (CA)

(72) Inventor: Fernando DiCarlo, Woodbridge (CA)

(21) Appl. No.: 14/573,061

(22) Filed: Dec. 17, 2014

Related U.S. Application Data
(63) Continuation-in-part of application No. 14/277,035, filed on May 13, 2014.
Application No. 14/277,035 is a continuation-in-part of application No. 14/143,629, filed on Dec. 30, 2013.
Application No. 14/143,629 is a continuation-in-part of application No. 13/936,189, filed on Jul. 7, 2013, now Pat. No. 9,017,158.
Application No. 13/936,189 is a continuation of application No. 13/077,841, filed on Mar. 31, 2011, now Pat. No. 8,491,376.

(51) Int. Cl. G07F 17/32; G07F 17/34

(52) U.S. Cl. CPC G07F 17/3213; G07F 17/34

(57) ABSTRACT

A method, apparatus, and computer readable storage to implement a slot machine (or other game) which allows the player to fund a slot machine game using tokens and receive play credits used to play (wager). The slot game spins reels and awards win credits. The player can exchange win credits for physical prizes, one of physical prizes being a commodity such as silver bullion. The silver bullion can then be purchased from the player by the house for play credits, thus effectively taking the player's silver bullion and providing him additional play credits to wager (play with).

### CROSS REFERENCE TO RELATED APPLICATIONS

This application is a continuation in part of application Ser. No. 14/277,035, filed on May 13, 2014, which is a continuation in part of application Ser. No. 14/143,629, filed on Dec. 30, 2013, which is a continuation in part of application Ser. No. 13/936,189, filed on Jul. 7, 2013, which is a continuation of application Ser. No. 13/077,841, filed on Mar. 31, 2011. All four of these applications are incorporated by reference herein in their entireties.

### BACKGROUND OF THE INVENTION

### Field of the Invention

The present general inventive concept is directed to a method, apparatus, and computer readable storage medium directed to a slot machine game.

### SUMMARY OF THE INVENTION

It is an aspect of the present invention to provide a slot machine game system.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a drawing of a slot machine style of game when a player makes an entry/bet, according to an embodiment;

FIG. 2 is a drawing of a slot machine game when the player spins the reels, according to an embodiment;

FIG. 3 is a drawing of a slot machine game after the spin is complete, according to an embodiment;

FIG. 4 is a drawing of a slot machine game when a skill game is initiated, according to an embodiment;

FIG. 5 is a drawing of a slot machine game when an animated bar has moved to the right, according to an embodiment;

FIG. 6 is a drawing of a slot machine game when the animated bar has moved to the left, according to an embodiment;

FIG. 7 is a drawing of a slot machine game when the animated bar has moved further to the left, according to an embodiment;

FIG. 8 is a drawing of a slot machine game when the animated bar has moved to the leftmost position, according to an embodiment;

FIG. 9 is a drawing of a slot machine game when the animated bar is stopped by the player, according to an embodiment;

FIG. 10 is a drawing of a slot machine game after the game is completed, according to an embodiment;

FIG. 11 is a drawing of a slot machine game beginning a new game, according to an embodiment;

FIG. 12 is a flowchart illustrating an exemplary method of implementing a slot machine game incorporating a skill element, according to an embodiment;

FIG. 13 is a block diagram illustrating exemplary hardware that can be used to implement the present invention, according to an embodiment;

FIG. 14 is a block diagram illustrating hardware that can be used to implement a game on a system, according to an embodiment;

FIG. 15 is a drawing of exemplary rules for a slot game, according to an embodiment;

FIG. 16 is a flowchart illustrating an exemplary method of implementing a slot machine wagering system, according to an embodiment;

FIG. 17 is a drawing illustrate exchange screens, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a slot machine game that incorporates a skill aspect. A typical slot machine game can be implemented, for example as described in U.S. Pat. No. 7,749,063, which is incorporated by reference herein in its entirety. As known in the art, a player makes a wager (using credits which can be exchanged for cash) and spins reels on a slot machine. The reels stop at random positions, and certain predetermined combinations on active paylines (each payline is predetermined line of symbols) will win awards (combinations that are not predetermined combinations do not pay awards). A payout (award) made to the player is the respective award for each active (bet on) payline added together.

Typically, when reels stop spinning and the reels form predetermined combinations, the player wins a respective award which is added to the player's credit meter (which can be cashed out at any point in time by the player). According to the present inventive concept, the after the reels stop spinning the amount the player would win (all awards for all active paylines) is considered a “potential win” and is not yet awarded the player. The player then plays a skill game (element) in which the player tries to earn 100% of the potential win by manipulating physical controls in order to achieve a goal. If the player completes the goal perfectly the player will win 100% of the potential win. If the player does not complete the goal perfectly, the player will win less than 100% of the potential win.

Some jurisdictions only allow wagering on games of skill. Thus, the skill element as described herein would add an element of skill to a traditional slot machine game, or any other potential game that awards a prize (e.g., video poker, bingo, keno, etc.)

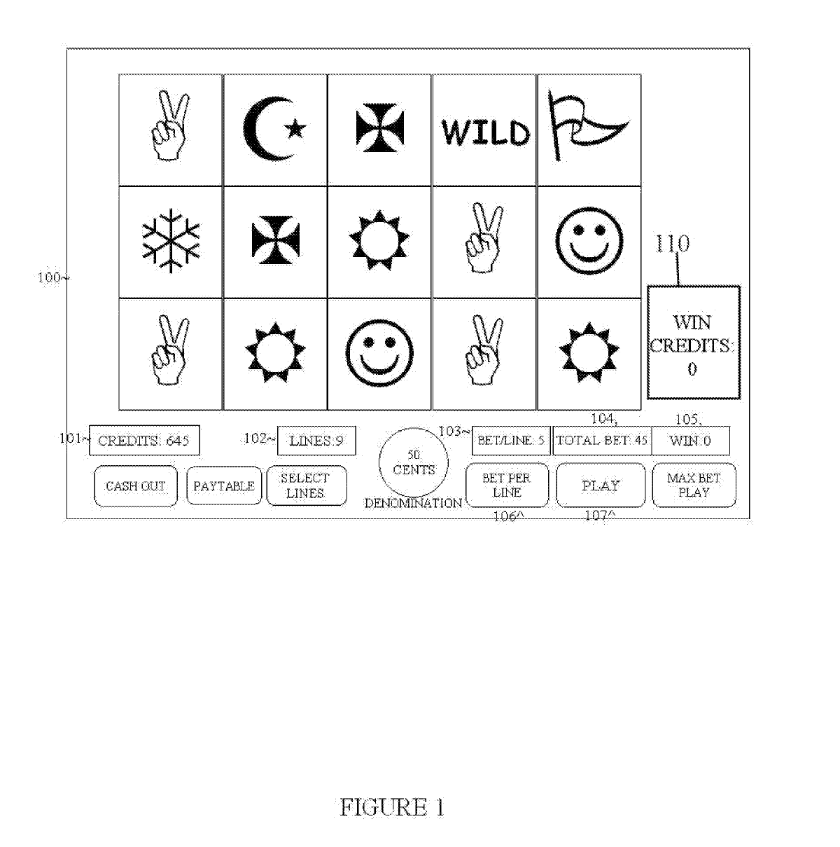

FIG. 1 is a drawing of a slot machine style of game when a player makes an entry/bet, according to an embodiment. “Wager” and “bet” as used herein are synonymous.

An electronic output device 100 displays the game. A play credit meter 101 (also referred to as “credits”) shows how many play credits (or points, sweepstakes, points, etc.) the player currently has. Play credits are credits that the player purchases and uses to play the games. A line meter 102 shows how many paylines (lines) the player bets on (in this example game the game has a maximum of 9 lines). A bet per line meter 103 shows how many credits per line the player is betting on. A total bet meter 104 shows the player's total bet (typically this amount is equal to the bet per line multiplied by the number of lines bet). A win meter 105 shows how many credits the player has won on the last spin. A bet per line button 106 allows the player to set his or her bet per line (e.g., number of credits per line). A play button 107 allows the player to play (spin the reels using the parameters the player has chosen).

A win credits meter 110 shows the number of win credits the player possesses. There are two types of credits which are entirely separate quantities, play credits (shown on the play credits meter 101) and win credits (shown on the win credits meter 110). The play credits are used to play the game (and each wager amount when made is deducted from the play credits meter 101). Any winnings from a game are added to the win credits meter 110.

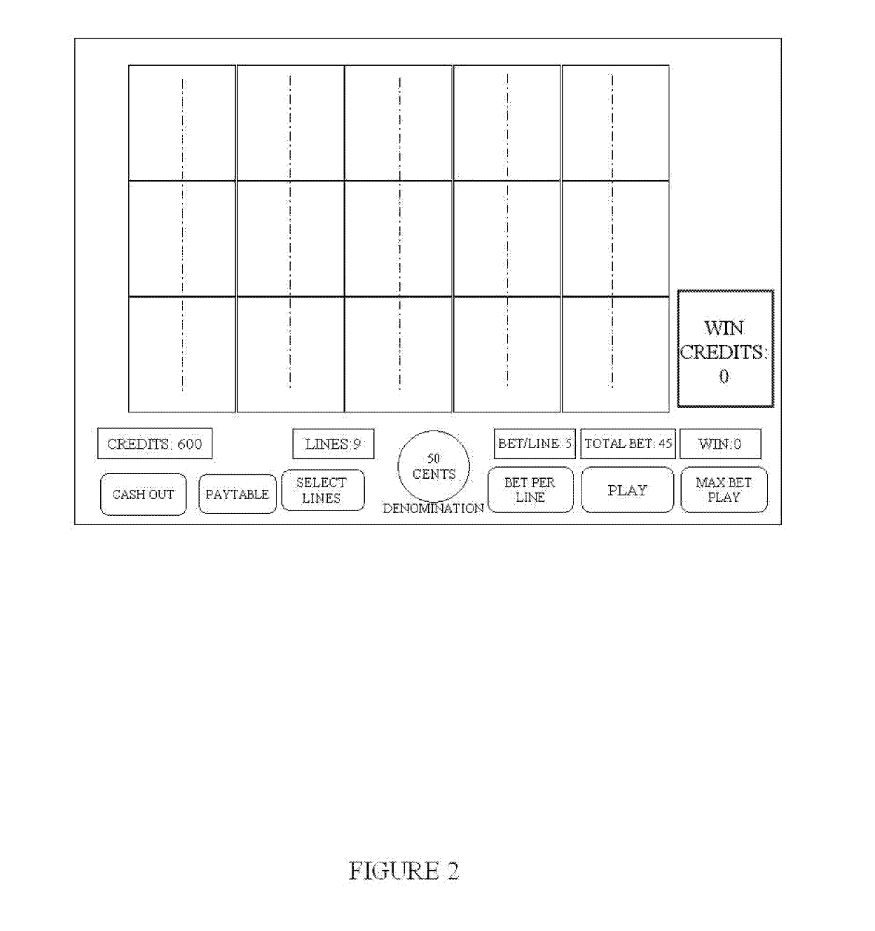

FIG. 2 is a drawing of a slot machine game when the player spins the reels, according to an embodiment.

After the player presses the play (or spin or reveal) button 107 in FIG. 1, the reels spin as illustrated in FIG. 2. The spin typically lasts for about a second and each of the five reels stops at a random position. Each reel can have a predetermined number of symbols on it, for example 24, 36 or any other number. Reels can be physical (mechanical) or virtual (displayed on an electronic output device).

Note that the wager amount has been deducted from the amount of play credits shown in the play credit meter 101.

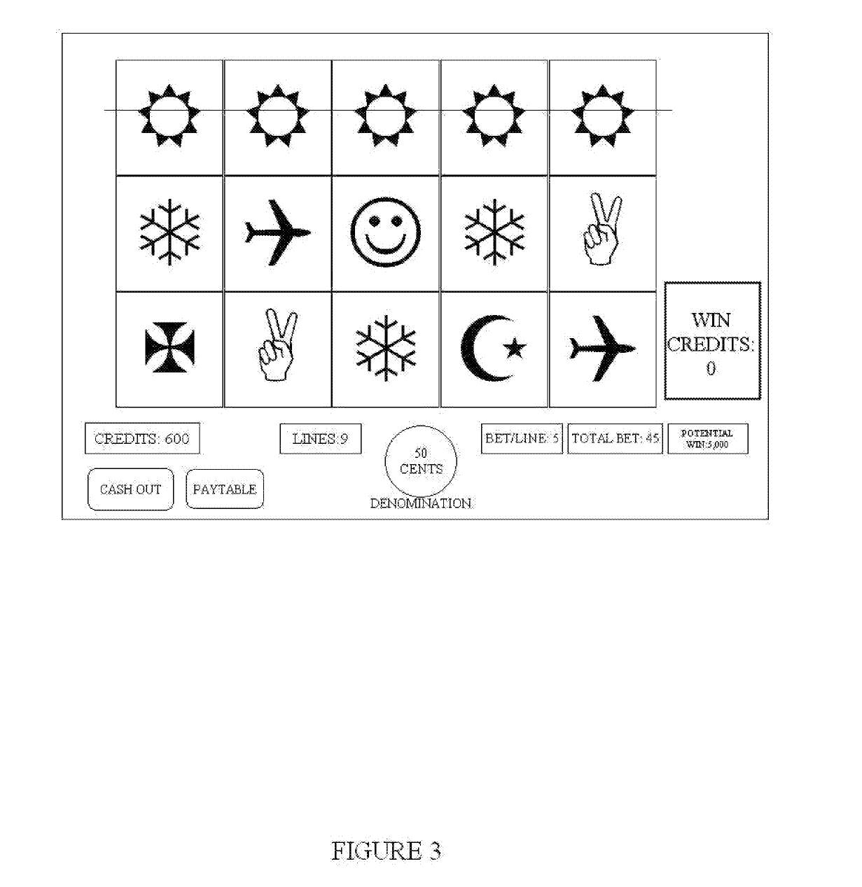

FIG. 3 is a drawing of a slot machine game after the spin is complete, according to an embodiment.

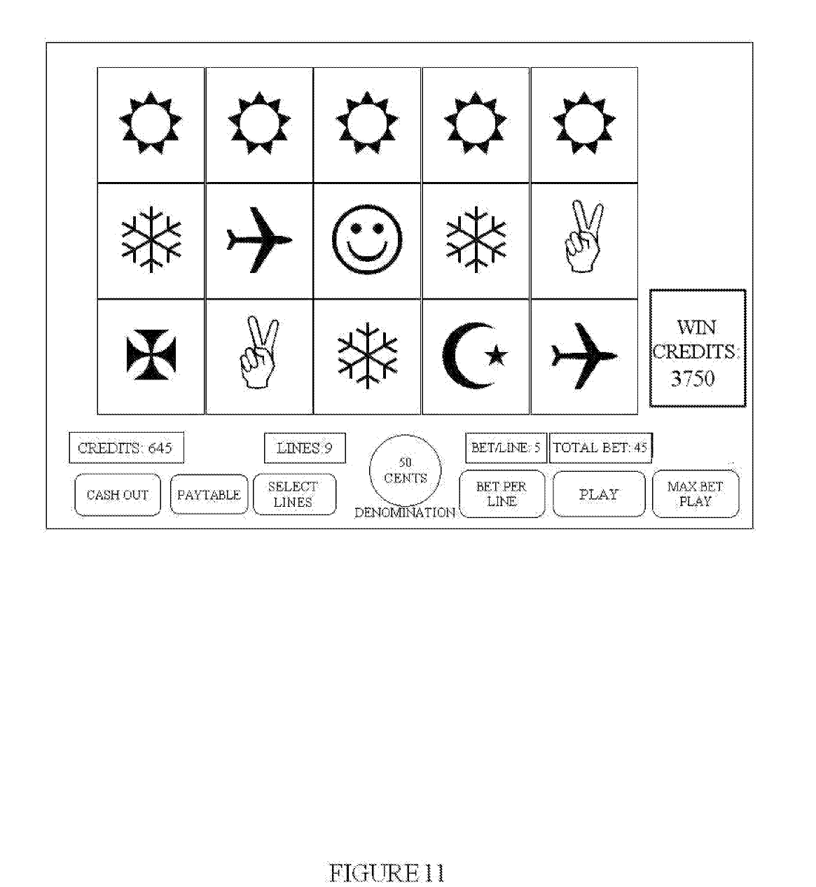

After the reels spin, the come to a stop as illustrated in FIG. 3. Here the player has bet on all nine paylines (see FIG. 11), with five coins bet per line. The player has achieved one winning payout (line 1, FIG. 11) for a potential win of $5,000 ($1,000 times 5 coins bet per line). However, unlike a traditional slot machine game, the player is not yet awarded this (or any award). The player will play a skill game in order to earn as much of the $5,000 as possible.

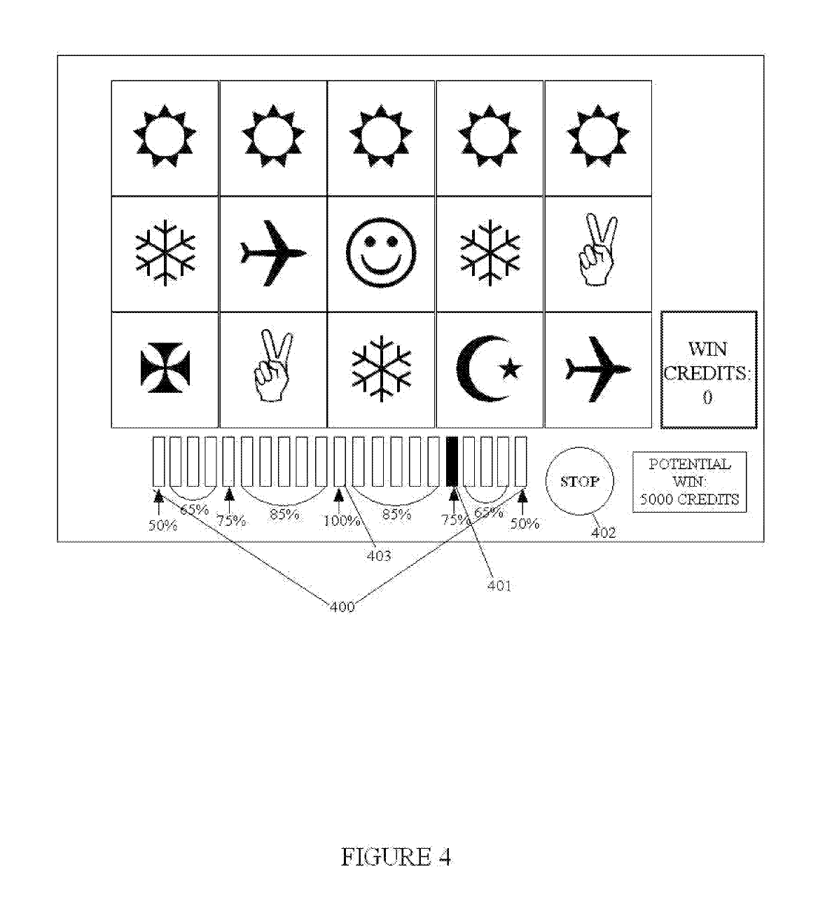

FIG. 4 is a drawing of a slot machine game when a skill game is initiated, according to an embodiment.

A skill meter 400 is displayed which shows 21 discrete bars (although any number of bars can be used). One of these bars is a highlighted bar 401. The highlighted bar 401 appears in a different color (or shape, etc.) than the other bars.

The highlighted bar will move (animate) back and forth in a “ping pong” fashion from left to right back to left again, etc. The highlighted bar will move to the right and when it reaches the rightmost bar it will change direction and move to the left and when it reaches the leftmost bar it will change direction again and move back to the right. This animation will repeat indefinitely until the player presses the stop button 402. Typically, the highlighted bar will remain highlighted for a fixed amount of time (e.g., two tenths of a second) before the highlighted bar becomes the next bar. When the stop button 402 is pressed, the highlighted bar no longer will move and will remain “frozen” so the player can see where the highlighted bar is.

It is the player's goal to press the stop button 402 (by touching the stop button 402 on a touch screen, or pressing a physical button on the device, or clicking a mouse, etc.) when the highlighted bar is the center bar 403. If the player presses the stop button 402 when the highlighted button is the center bar 403 then the player wins 100% of the potential award. The location of the highlighted bar when the player presses the stop button 403 determines the percentage of the potential award that the player wins (the actual award). Typically, the further away from the center that the highlighted bar is when the stop button 402 is pressed the lower the percentage of the potential award that the player gets (the actual award)

Thus, a player with quick reflexes (and good hand-eye coordination) may be able to stop the highlighted bar at or close to the center (winning the biggest percentage of the potential award), while a player with slow reflexes (and poor hand/eye coordination) will fare worse than the skilled player.

Table I below illustrates the different possible locations of the highlighted bar (after the stop button is pressed) and the respective percentage of the potential award the player would win (actual award) at that position. Of course, this represents merely one example and it can be appreciated that other configurations of payout percentages and their respective locations/ranges of the bars can be used. In addition, in an alternate embodiment, certain location(s) of the highlighted bar could pay more than 100% of the potential award. In addition to a linear bar, other shapes of the moving bar could be used as well (e.g., circle, etc.) While not pictured in Table I, certain position(s) could have a 0 award (the player wins nothing), e.g., position 1 has an award of 0 instead of 50%.

TABLE I

| position | % of potential award |
|---|---|
| 1 | 50 |
| 21 | |
| 2-4 | |
| 18-20 | 65 |
| 5 | 75 |
| 17 | |
| 6-10 | 85 |
| 12-16 | |
| 11 | 100 |

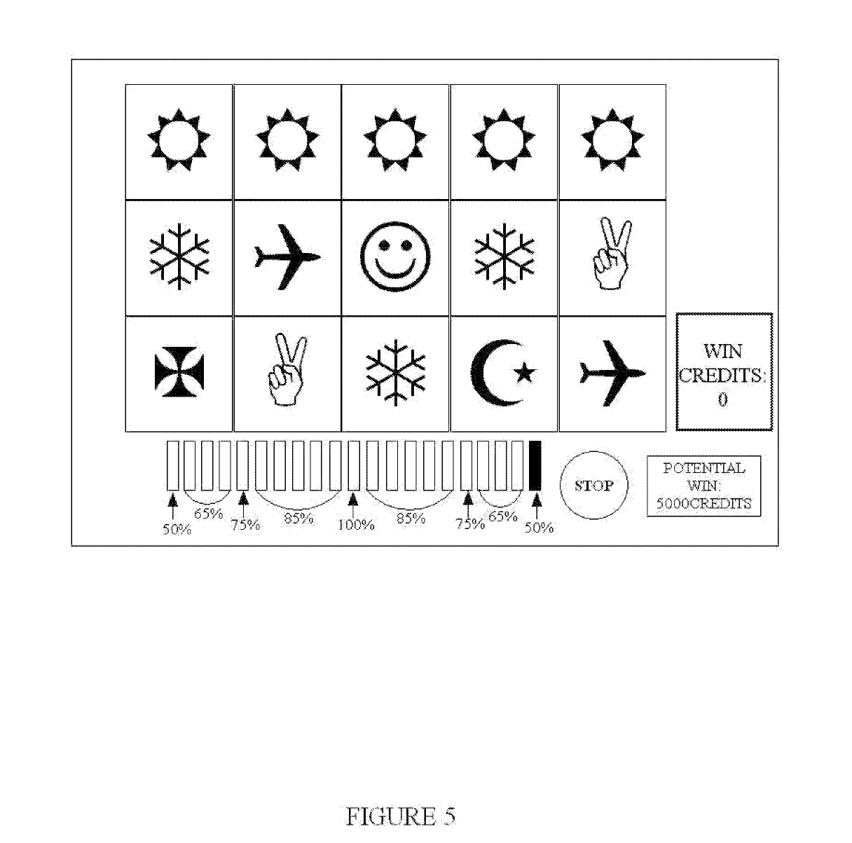

FIG. 5 is a drawing of a slot machine game when an animated bar has moved to the right, according to an embodiment.

The highlighted bar has moved to the rightmost position on the skill meter and then will reverse direction and start moving again to the left. It is noted that while FIG. 4 showed the highlighted bar at position 17 and FIG. 5 shows the highlighted bar at position 21, the computer would also show the highlighted bar moving through positions 18-20 as well, but figures showing the highlighted bar at these positions (and all the other unillustrated positions as well) are omitted for simplicity. The player can press the stop button when the highlighted bar is at any of the possible positions.

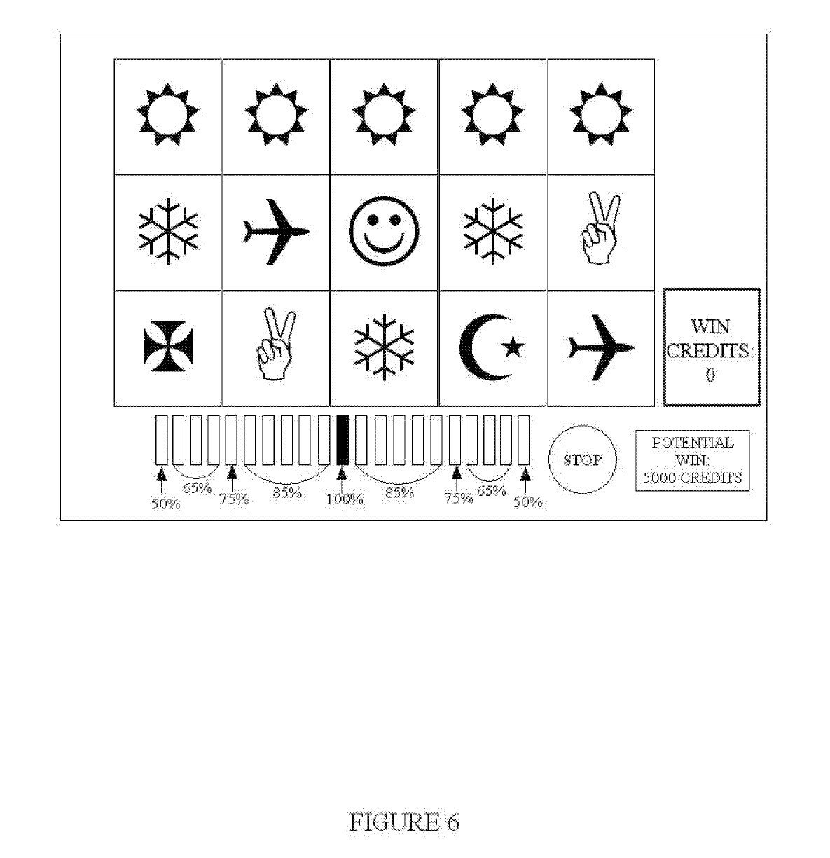

FIG. 6 is a drawing of a slot machine game when the animated bar has moved to the left, according to an embodiment.

In FIG. 6, the bar is now moving to the left. If the player were able to press the stop button at this position (where the highlighted bar is in the center), the player would win an actual award of 100% of the potential award ($5,000). Of course, this is the player's goal.

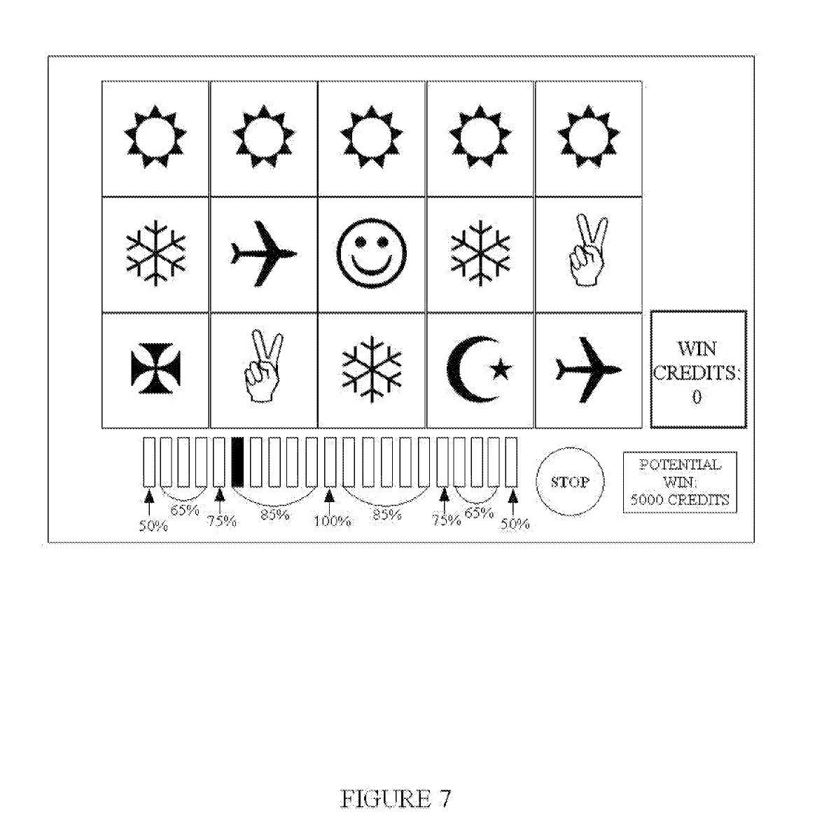

FIG. 7 is a drawing of a slot machine game when the animated bar has moved further to the left, according to an embodiment.

FIG. 7 shows the highlighted bar continuing to move to the left. As stated above, the computer would show the highlighted bar moving through each of the positions, but drawings showing the highlighted bar at each individual position is omitted for simplicity.

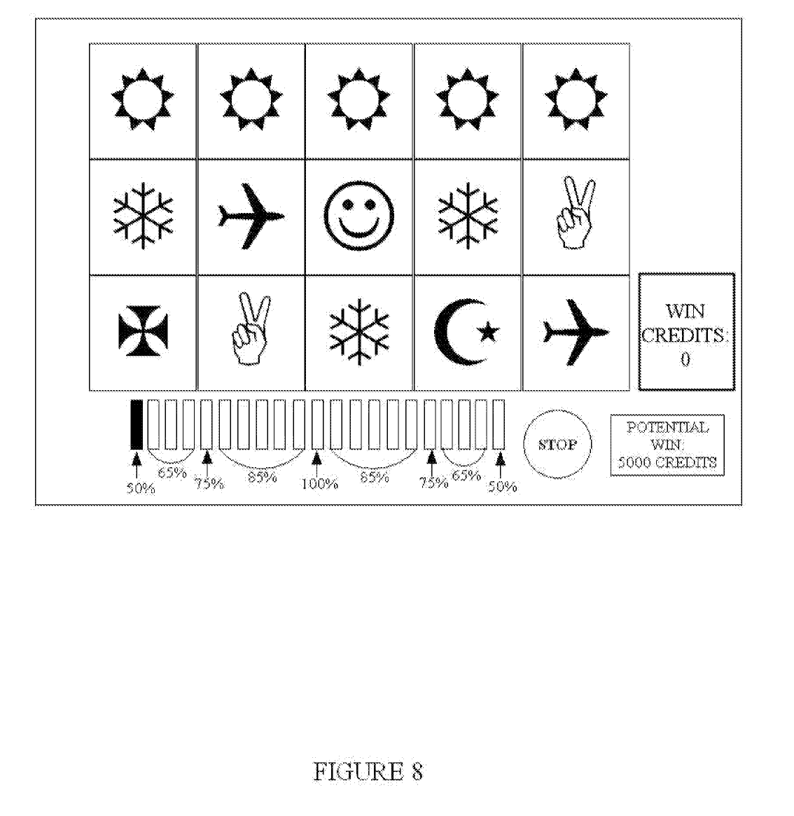

FIG. 8 is a drawing of a slot machine game when the animated bar has moved to the leftmost position, according to an embodiment.

The highlighted bar is now at the leftmost position. The player would not wish to press the stop button at this position as the player would win the lowest possible award (50% of the potential award or $2,500). In an embodiment, stopping the highlighted bar in the wrong position could result in zero award.

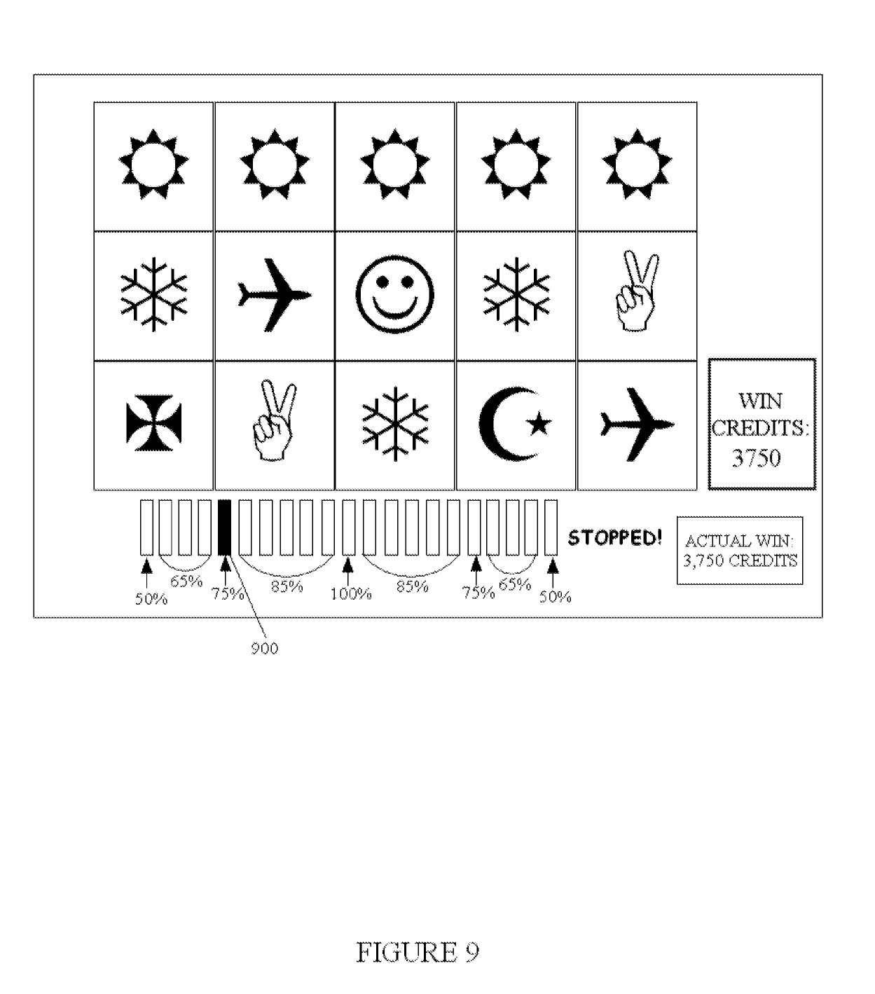

FIG. 9 is a drawing of a slot machine game when the animated bar is stopped by the player, according to an embodiment.

The highlighted bar is at the fifth position when the player presses the stop button. Once the stop button is pressed, the stop button is removed and can no longer be pressed. The highlighted bar 900 now freezes in position and can also be considered a frozen bar 900 (since it will no longer move). Since the highlighted (frozen) bar is in position five, according to Table I the player wins 75% of the potential award (5,000) or 3,750 credits. This screen can remain until the player presses the screen (or other action) so that the player can inspect the skill meter and understand what has happened. Note that the win credit meter on the right (which says “win credits 3750”) is the amount of win credits the player has earned. The win on this game (3750) is added to the current amount of win credits for the machine/player.

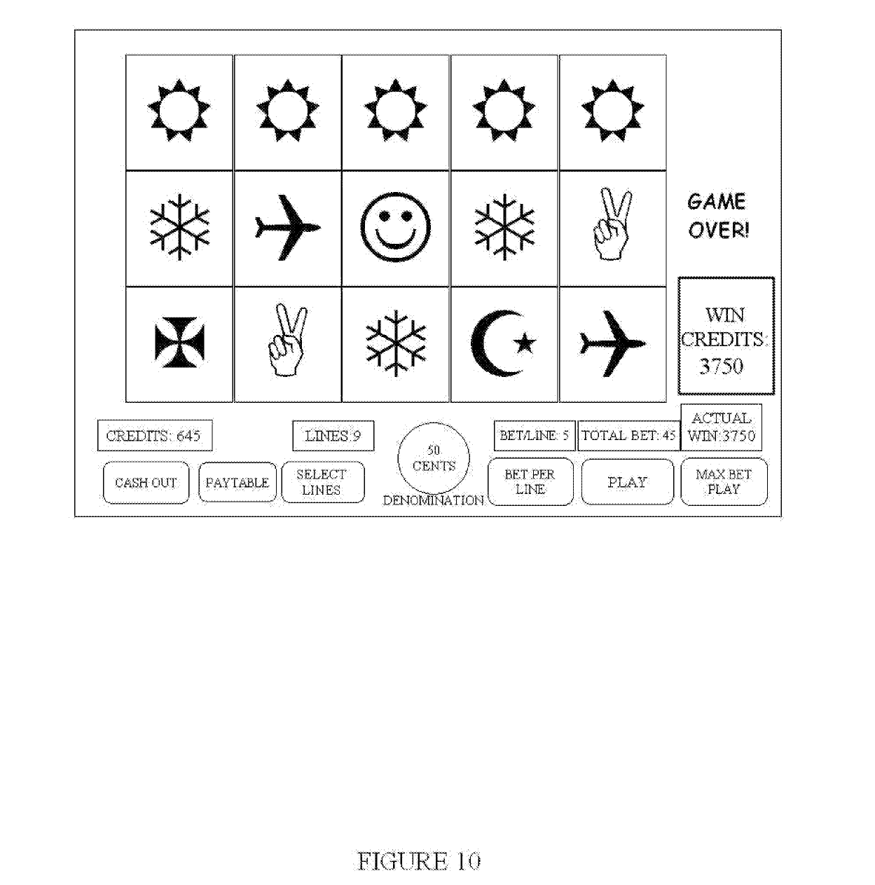

FIG. 10 is a drawing of a slot machine game after the game is completed, according to an embodiment.

In FIG. 10, the game is over and the player's actual award of 3,750 credits was added to the win credit meter. The player can now play a new game by pressing the “play” button (which would use the paylines/bet amount from the prior spin) or the “max bet play” button (which automatically bets the maximum bet and paylines), which would spin the reels again.

In an alternate embodiment, instead of the player trying to stop the highlighted bar in the center of the skill meter, other configurations of the skill meter can be used, for example one wherein the player tries to stop the highlighted bar in the rightmost or leftmost (or any other) bar. Table II below represents a configuration wherein the player tries to stop the highlighted bar at the rightmost position (bar). In this configuration, the skill meter has 30 bars (numbered 1 to 30 from the left) wherein the player will of course try to stop the highlighted/frozen bar on the rightmost (thirtieth) bar. Note that in this example, the player can earn an actual award of 101% of the potential award if the player stops the highlighted bar in the rightmost (30^{th}) position (in other words the frozen bar is in position 30).

TABLE II

| position | % of potential award |
|---|---|
| 1-5 | 50 |
| 6-15 | 65 |
| 16-25 | 75 |
| 26-28 | 85 |
| 29 | 100 |
| 30 | 101 |

It is further noted that the skill meter is not limited to a horizontal moving highlighted bar but alternatively can be presented as a set of vertical bars in which the highlighted bar moves up and down vertically (or even diagonally). As an alternative to using bars, any other type of icon can be used as well.

FIG. 11 is a drawing of a slot machine game beginning a new game, according to an embodiment.

A new game is not being initiated with a wager amount of 45 again. When the play button is pressed, the credit meter (showing the amount of play credits) will drop from 645 to 600 and the reels will spin. Any win earned on the new spin will be added to the win credit meter.

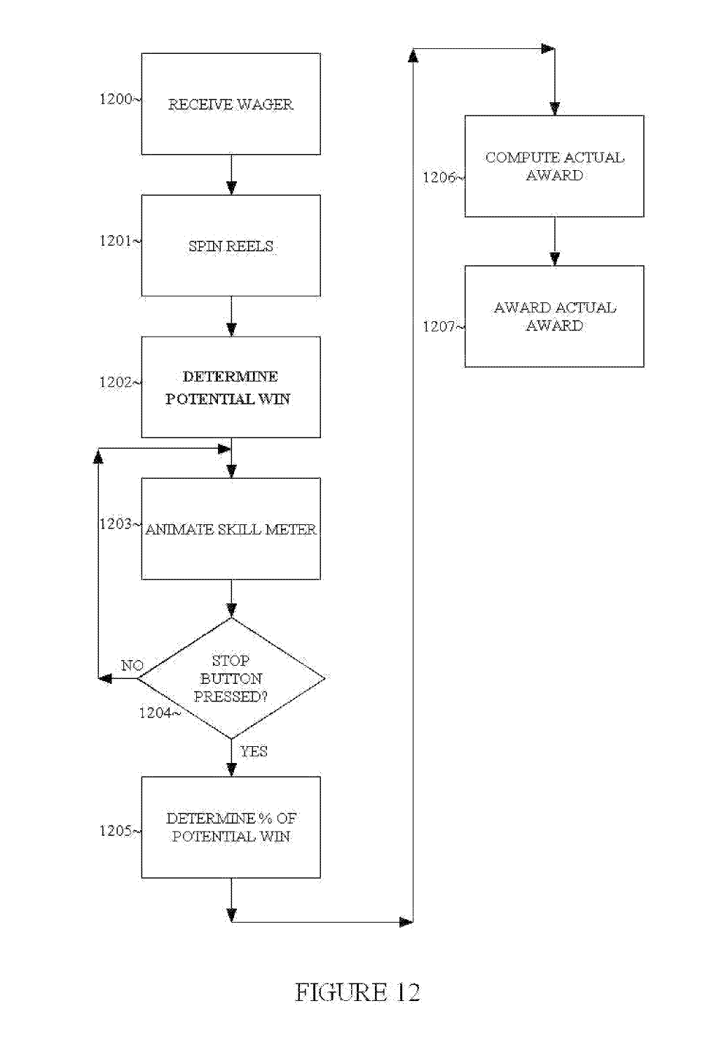

FIG. 12 is a flowchart illustrating an exemplary method of implementing a slot machine game incorporating a skill element, according to an embodiment.

The method can begin with operation 1200, which receives a wager from a player. This can be done as known in the art. Typically, the player first funds the machine by providing a source of credits to the machine which the player converts to play credits. The source of credits can be cash, electronic funds, a card which contains play credit, a cashless ticket/voucher, or any other known method.

There are two quantities (play credits which are used for wagering and win credits which are used for redemption). The player pays play credits to play but wins awards in the form of win credits (or win points, or other points, etc.). This is different to the traditional method of wagering described herein in which wagers are made using credits and awards are paid using credits. The player is always free to redeem their win points (or points) at any time, which can be redeemed in the form of a store coupon (at the store where the game machine the player is playing is located, a gift card, cash, tangible goods, etc.) For example, the player can start with 1000 play credits and each spin on the slot game costs 10 play credits. When the player wins a game the player wins win credits. When the player has used up all of his/her play credits, the player cannot play any further until the player has replenished the amount if play credits he/she has.

Once the machine has enough play credits to play, the player makes a wager by indicating (using buttons) how much the player wishes to bet. When the player wants to finally place the wager, the player issues a command (e.g., presses a button) which places the wager (and the wager amount is then deducted from the player's credit meter).

From operation 1200, the method proceeds to operation 1201, which spins the reels. Typically, the electronic output device will display a “reel blur” indicating that the reels are spinning. The reels will automatically stop at random positions after typically 1-2 second of spinning.

From operation 1201, the method proceeds to operation 1202, which computes a potential win (or potential award). The potential win is computed as the sum of each award for each active payline. Each award is determined by comparing the symbols falling under that respective payline against a paytable (see FIG. 11) to determine a respective payout, and the award is determined by multiplying the payout by the number of credits (coins) bet per payline. Combinations which are not listed as winning combinations are losing combinations, and paylines with losing combinations have an award amount of zero. In an embodiment, as described herein the potential win/award is determined based on a reveal from a finite pool, in other words it may have been determined randomly at an earlier time (when the finite pool was generated) but at the current time the potential win/award is merely electronically retrieved from the finite pool.

The potential award is displayed but not yet awarded to the player as the player must enter the skill element (operations 1203-1206) in order to determine the actual award (which is a function of the potential award).

From operation 1202, the method proceeds to operation 1203, which moves the highlighted bar one position to the next position. If the highlighted bar reaches the end of the skill meter, then the direction of the highlighted bar will reverse and proceed in the opposite direction. Technically, the highlighted bar is moved by highlighted the next position and removing the highlight for the current position. The current position now becomes the next position.

From operation 1203, the method proceeds to operation 104, which determines if the stop button is pressed. If not, the method returns to operation 1203. If the stop button is pressed, then the method proceeds to operation 1205. It is noted that in an optimal embodiment, after a predetermined and excessive amount of time has passed before the player has pressed the stop button (e.g., 10 minutes), the game can automatically stop the bar (either at a random time or to award the minimum percentage possible) in order to avoid an infinite loop.

In operations 1203-1204, the highlighted bar is moved back and forth repeatedly until the stop button is pressed. The speed of the moving bar is fast enough so that it would not be easy for the typical person to stop it in a particular location. However, the speed is slow enough that the average player's mechanical skill would still give the player an advantage in stopping the highlighted bar in the desired location (or a position near the desired location) as compared to the bar stopping in a purely random location. The speed the highlighted bar moves is constant, although in an alternative embodiment the speed can change. As the player improves their hand-eye coordination, the potential to stop the indicator at the ultimate stop position improves, thus giving the skilled player a higher potential to win than the lesser skilled player.

From operation 1204, if the stop button is pressed the method proceeds to operation 1205, which determines a percentage of the potential win to award the player. This is determined as a function of the location of the highlighted (now frozen) bar. A table such as that illustrated in Table I or II (or any other configuration) can be used.

From operation 1205, the method proceeds to operation 1206, which computes the actual award to award the player. Once the percentage of the potential award is determined from operation 1205, this percentage is applied to the potential award to determine the actual award (e.g., if the potential award is 100 credits and the percentage is 50%, then the actual award is 50 credits).

From operation 1206, the method proceeds to operation 1207, which awards the actual award (computed in operation 1206) to the player. This typically entails adding the actual award (which is also displayed to the player) to the player's win credit meter (but not the play credit meter as these are two separate quantities).

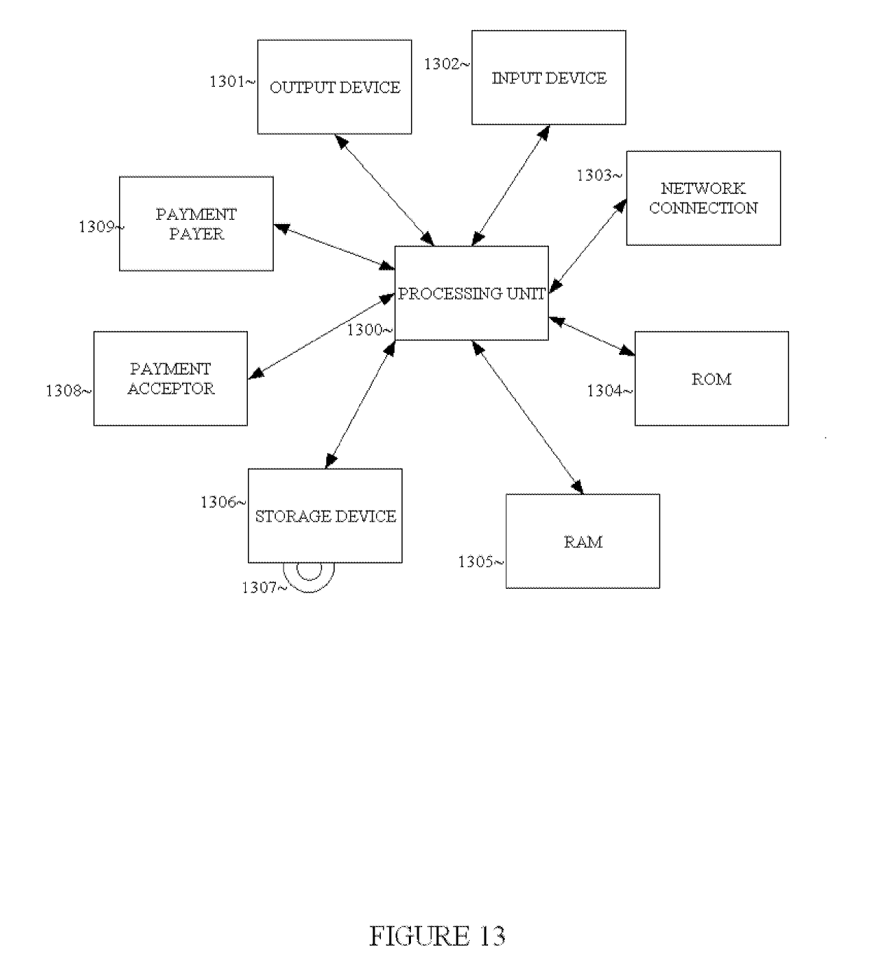

FIG. 13 is a block diagram illustrating exemplary hardware that can be used to implement the present invention on an electronic gaming device, according to an embodiment.

A processing unit, such as a microprocessor and associated structure (e.g., bus, cache, etc.), is connected to an output device 1301 (e.g., LCD, CRT, touch-screen, etc.) and an input device 1302 (e.g., touch-screen, keyboard, mouse, physical buttons, etc.) All inputs/decisions from the player can be entered by the player using the touch-screen and a graphical user interface. All outputs described herein can also be displayed on the touch-screen. The processing unit 1300 can be configured and programmed to execute instructions that will implement any of the methods described herein on the electronic device. The processing unit 1300 can also be connected to a network connection 1303 which can connect the system to a computer communications network (e.g., Internet, LAN, WAN, etc.) The processing unit 1300 can also be connected to a ROM 1304 and a RAM 1305 and a storage device 1306 (e.g., BLU-RAY drive, hard disk drive, floppy disk drive, CD-ROM drive, etc.) and a non-transitory computer readable storage medium 1307 (e.g., BLU-RAY disc, CD-ROM, EPROM, etc.) The computer readable storage medium 1307 can store instructions and assets in order to direct the processing unit 1300 to implement the methods described herein. The processing unit 1300 can also be connected to a payment acceptor 1308 which accepts consideration from the player in order to pay for the spins of the slot game. The payment acceptor 1308 can also be a coin slot which receives particular coins (or tokens) and credits them appropriately (e.g., 1 Toonie results in 100 play credits being added to the player's play credit meter).

The payment acceptor 1308 can be a bill acceptor, an electronic payment acceptor, a ticket (cashless voucher) reader, etc. The payment acceptor 1308 can also be a card reader which can read an electronic card which has an account number encoded on it, the account associated with the account number contains a respective number of play credits which can be used to pay for the spins.

Also connected to the processing unit 1300 is a payment payer 1309 which, upon a cashout request by the player, issues the player actual payment for the amount of credits the player currently possesses. The payment payer can be a cash payment mechanism which actually dispenses cash or coins, or a ticket dispenser which dispenses a voucher which can be redeemed (at a cashier or clerk at the location) by the player for a respective amount of cash.

It is further noted that FIG. 13 describes components to the system however it is not necessary that all components be actually directly connected to the processing unit 1300. It is sufficient that the components are operationally connected (can work together with the processing unit) in order to effectuate their functions. In addition, instead of a single processing unit 1300, multiple processing units (not pictured) can be implemented.

The methods described herein can be implemented by any type of gaming system, e.g., a slot machine (video or mechanical) in a casino, a computer (personal computer or portable device) playing at an online casino over the Internet, and a game promotion/system that uses play credits to play, etc.

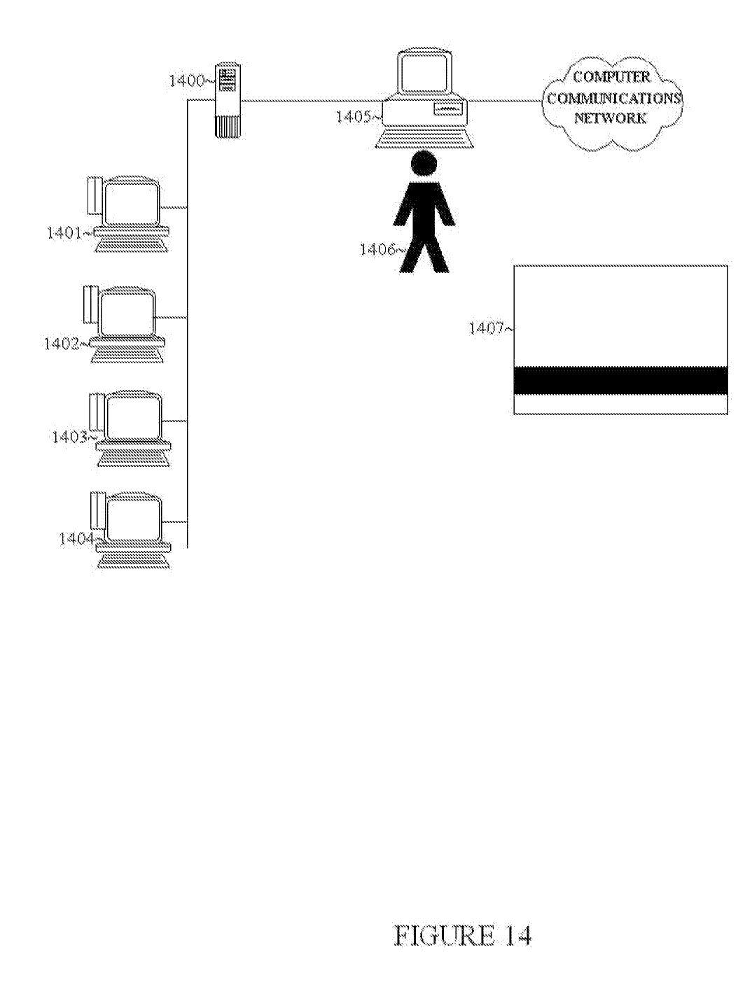

FIG. 14 is a block diagram illustrating hardware that can be used to implement a game on a system, according to an embodiment.

A “Sweepstakes parlor”, internet café, or any other establishment can offer the game herein and can be implemented as follows. A server 1400 can distribute a finite pool of prizes across a number of winning and non-winning “tickets.” This can be done periodically (e.g., every day before play is allowed). For example, a distribution can be predefined as allocating 100 tickets, with 90 non-winning tickets (no award), 9 winning $5 and 1 winning $50. The winners/non-winners are randomized such that players cannot determine whether they are a winner/non-winners without actually playing the system.

A player (not pictured) can purchase a card 1407 (which can have for example phone time or other valuable goods or services) for cash from an attendant 1406. The attendant 1406 will activate the card 1407 using a workstation 1405 which can be connected to a computer communications network such as the Internet. In an embodiment the workstation 1405 (and the game terminals) are not connected to the Internet but only a local communications network (closed loop). The card in addition to having telephone time (or other value) can come with free play credits (e.g., 1000 play credits). The player can also purchase additional phone time (using cash, credit card, etc.) at the machine the player is currently playing at (see FIG. 13) which will award the player win credits.

The player could then take the card 1407 to one of a plurality of game terminals 1401, 1402, 1403, 1404 which are in communication with the server 1400. Each game terminal has a card reader wherein the player can enter or swipe the card info 1407 so that the terminal can identify the account associated with the card 1407 and access the server 1400 to determine how many play credits the card 1407 has associated with it. Play credits cannot be converted directly into cash but can be used to play the game described herein (or any other game) in which if the player wins an award the award is in the form of win credits which can then be exchanged for prizes. Different prizes have a different cost in win credits.

When the player has entered the card info 1407 and the system determines that the card has play credits, the player can pay a predetermined number of play credits for each spin (play) of the game. That number of play credits would be deducted from the account associated with the card 1407 and the game begins.

The potential win is determined by using the finite pool of prizes and selecting one such prize at random or sequentially. The actual symbols displayed on the game can be reverse mapped from the prize to determine which symbols to actually display.

When the player is done playing, then the player can return to the attendant 1406 who can verify (using the card 1407) how many win credits the player has won. The attendant 1406 can then issue the player a prize selected by the player in exchange for a respective amount of win credits. Silver bullion can be one such prize that the player can convert their win credits in exchange for. Example, each silver bullion can cost 1000 win credits.

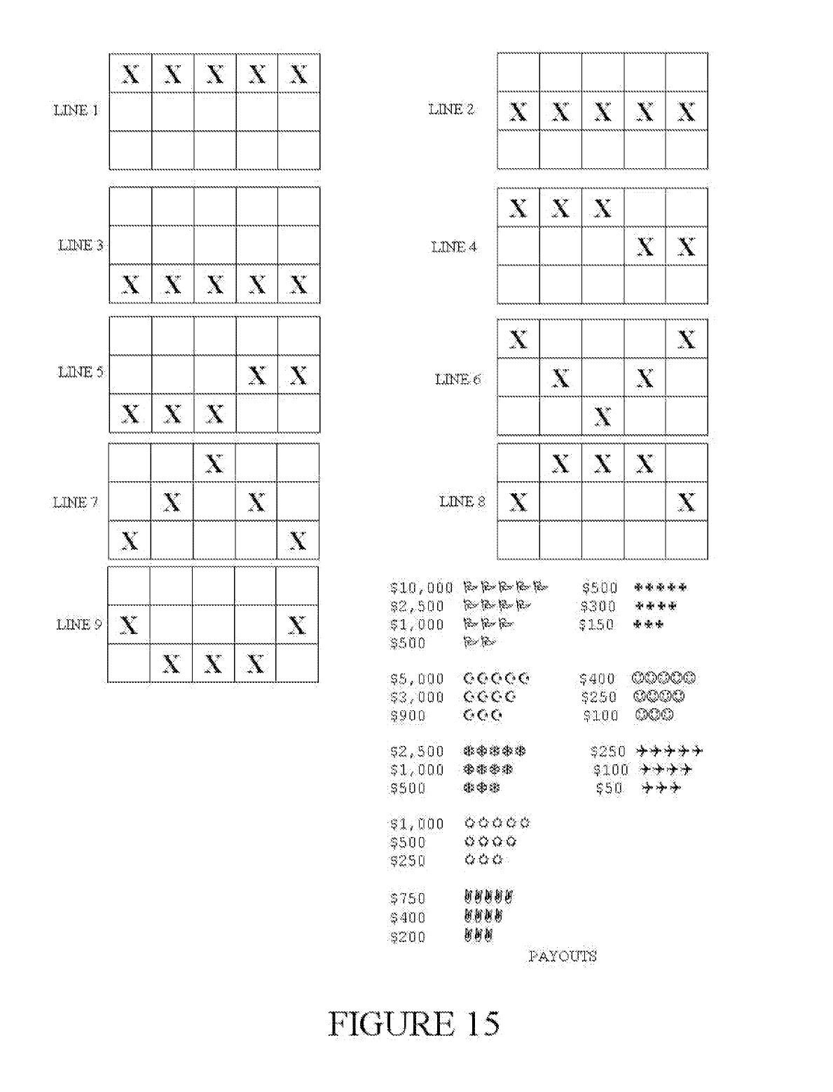

FIG. 15 is a drawing of exemplary rules for a slot game, according to an embodiment.

Shown are nine paylines for the game (the player is free to bet on 1-9 paylines at the player's option). Of course other numbers of paylines can be used (from 1-243 paylines), and the symbols forming each payline can be chosen by the game designers using any desired configuration.

Also shown is a paytable which can be used to determine awards for each active payline (payline the player has bet on). Payouts are typically paid from left to right, in other words, the leftmost symbol must start a combination. Of course, these payouts are just illustrated as an example, and any other set of payouts can be used. No representation is made that the payouts presented herein are mathematically proper.

Furthermore, the application of the skill element as described herein is not limited to a five reel slot game but can be applied to any type of slot game (e.g., 3 reel, 3×3 grid, etc.) or non-slot game (video poker) or virtually any type of wagering game at all. In addition, the present inventive concept is not limited to using the skill element described herein (the skill meter) and other mechanisms of introducing player skill can be used as well. Such mechanisms would presented an animated icon in which the player would be required to press one or more buttons (real of virtual) in order to effectuate a game action on the game which has a cause/effect relationship of determining a final state of the skill element which then determines a percentage of a potential award to actually award to the player.

The player can fund the game in a manner in which the player purchases tokens (which may or may not be negotiable, such as a negotiable Canadian Toonie). The Toonie can then be put into a slot on the gaming machine which would then be credited to the machine as credits. Each payline would be treated as a separate game, for example a 25 line game with 5 cents being bet per line would cost a total of 75 cents but each payline is considered an independent game and paid separate from the other paylines. There is also a maximum payout ratio on each payline, for example, 25:1. Thus, the top paying award on a payline would pay 25:1 of the wager on that payline, so for example a 5 cent bet on a payline would have a maximum award of 75 cents. The player can then play the slot machine game, and winnings are paid as win credits. The player can convert their win credits into silver bullion, and then barter their silver bullion back as play credits to wager some more.

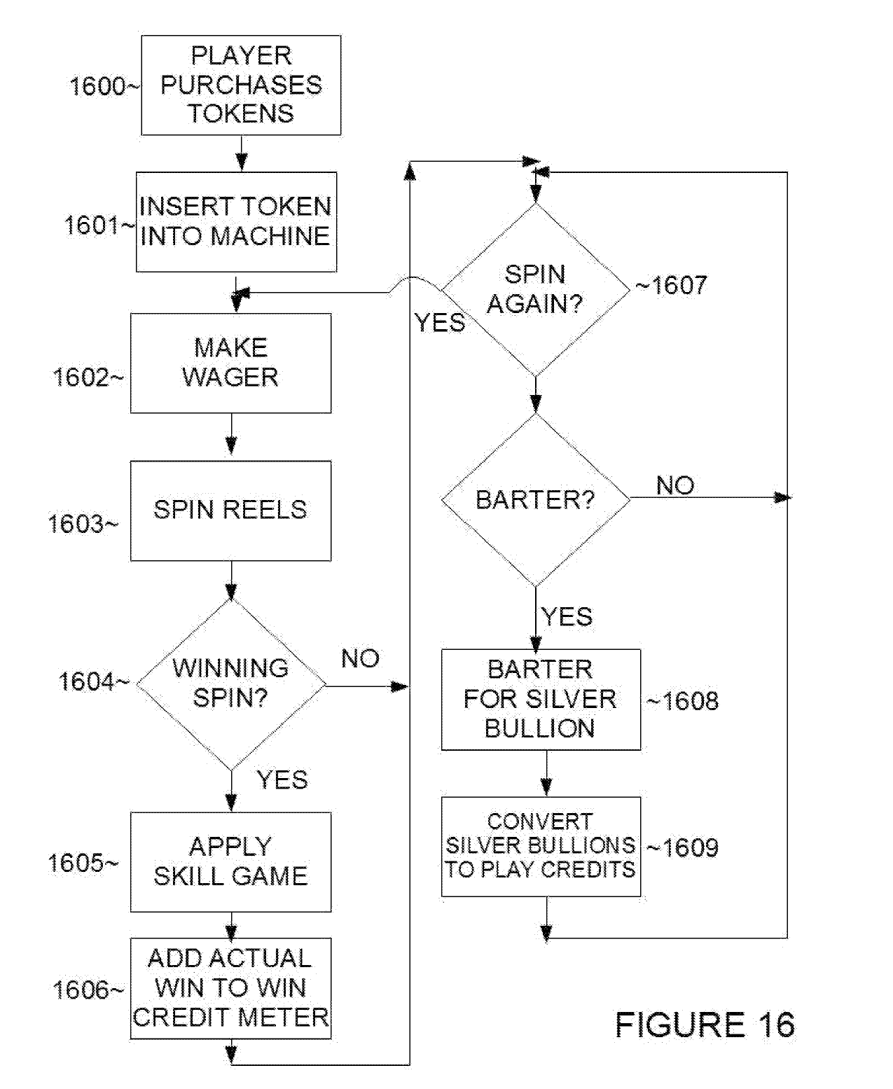

FIG. 16 is a flowchart illustrating an exemplary method of implementing a slot machine wagering system, according to an embodiment.

In operation 1600, the player purchases tokens. These can be special tokens used for a gaming machine or negotiable government sponsored coins. The purchase can be made using a credit card (or other electronic payment mechanism) or by physically presenting cash in exchange for the tokens at a counter in a store. The player can also bring their own such coins as well.

From operation 1600, the method proceeds to operation 1601, wherein the player inserts the tokens into a machine (one of the networking gaming machines 1401, 1402, 1403, 1404, etc.) Each such machine has a slot to deposit such a coin. The machine will then credit the player with a respective amount of credits based on a value of the token (e.g., one Toonie equals 10 credits).

From operation 1601, the method proceeds to operation 1602, wherein the player makes a wager. On the electronic output device, the player will indicate how much he/she wishes to bet per line and then press a button to initiate the spinning (invoking operation 1603). Note that each line is its own wager. So betting 1 play credit per line on a 15 line game would be a total wager of 15 play credits (15 individual separate games).

From operation 1602, the method proceeds to operation 1603, which spins the reels. The output device will display computer-animated spinning reels which will stop at random positions on each of the reels. The slot game can have 3 reels, 5 reels, or any number of reels. Each reel has a predetermined amount of symbols, such as 10, 24, 32, etc. Each time the reels are spun, the wager amount is deducted from the player's credit meter. The wager amount is the number of lines multiplied by the wager for each line. Typically, the wager amount for each line (line is synonymous with payline) is the same.

From operation 1603, it is determined in operation 1604 whether the spin is a winning spin. If the combination from the spin (in operation 1603) corresponds to a predetermined potential win (non-zero), then, then the method proceeds to operation 1605 which applies the skill game (as described herein) and determines an actual win from the potential win. Each line (payline) is a separate wager so this is performed for all paylines wagered on. If any one payline has a non-zero potential win then the method proceeds to operation 1605 which applies the skill meter illustrated in FIGS. 4-9 in order to determine the final win (award) amount.

From operation 1605, the method proceeds to operation 1606, which adds the actual win to the win credits (displayed on the win credit meter). then the method proceeds to operation 1607.

If in operation 1604, it is determined that the last spin is not a winning spin, then the method proceeds to operation 1607 (operation 1607 also follows operation 1606). In operation 1607, it is determined whether the player wishes to spin again (the player can press buttons on the touch-screen (or other input mechanism such as buttons, mouse, etc.) to make another wager of play credits which returns to operation 1602.

From operation 1606, the method proceeds to operation 1607, which determines whether the player spins again (plays a new game). The player presses buttons on the device (real or virtual) indicate his/her desire to play again. If the player spins again, then the method returns to operation 1602.

If in operation 1607, it is determined that the player does not want to play anymore (e.g., the player cashes out by pressing a cashout button), then the method proceeds to operation 1608, wherein the player can opt to barter his/her win credits for a silver bullion (or other object that has a fixed cash value). If the player presses a button that he/she wishes to barter for the silver bullion, then the method proceeds to operation 1608. Otherwise, the player can choose (by pressing buttons) continue to play again and return to operation 1607.

In operation 1608, the player can barter their win credits for a non-cash prize (such as silver bullion). The player would exchange his/her win credits displayed on the output device for the prize. For example, 1 silver bullion costs 100 win credits, so if the player has 230 win credits he/she can barter for 2 silver bullions (and have 30 win credits left). Win credits cannot be used for wagering and cannot be directly converted into play credits. The cost of silver bullion can also be determined based on a real time market value of silver, and thus it can fluctuate. The gaming machine would retrieve the current price of a silver bullion (that particular weight) so that the amount of win credits required to purchase one silver bullion would reflect the true market price at that time.

Thus, the player can play using play credits, win win credits, exchange the win credits for silver bullion, and then barter the silver bullion back for more play credits. The player would choose how many silver bullion the player wants to purchase (of course limited by the amount of win credits the player has, as the player can't purchase more silver bullion than his win credits will afford him).

In operation 1608, the player will indicate how many silver bullion (or other trinket, object, commodity, etc.) the player wishes to buy (barter) for their win credits. The system would then deduct the amount of win credits used for the exchange and award the player the purchases silver bullion (or other object).

By pressing buttons, the player can return to playing the game (operation 1607) or the player can now convert the silver bullions the player possesses into additional player credits (operation 1609). In operation 1609, the output device would indicate the exchange rate (how many player credits will be exchanged for each silver bullion). Once the player indicates how many silver bullion the player wishes to exchange for play credits, the system would make the exchange. This is done by deducting the amount of silver bullion bartered (exchanged) by the player from the player's account (which is also reflected on the gaming machine's output device). And the player's play credits are now increased by the respective amount. For example, if one silver bullion can be exchanged for 100 play credits, then if the player wishes to exchange three silver bullion then the player would receive 300 play credits. Of course, the player can only exchange an amount of silver bullion up to what the player currently possesses.

After the player has exchanged some (or all) of his/her silver bullion for play credits, then the player can continue to play the game some more (possibly using the new play credits the player just received).

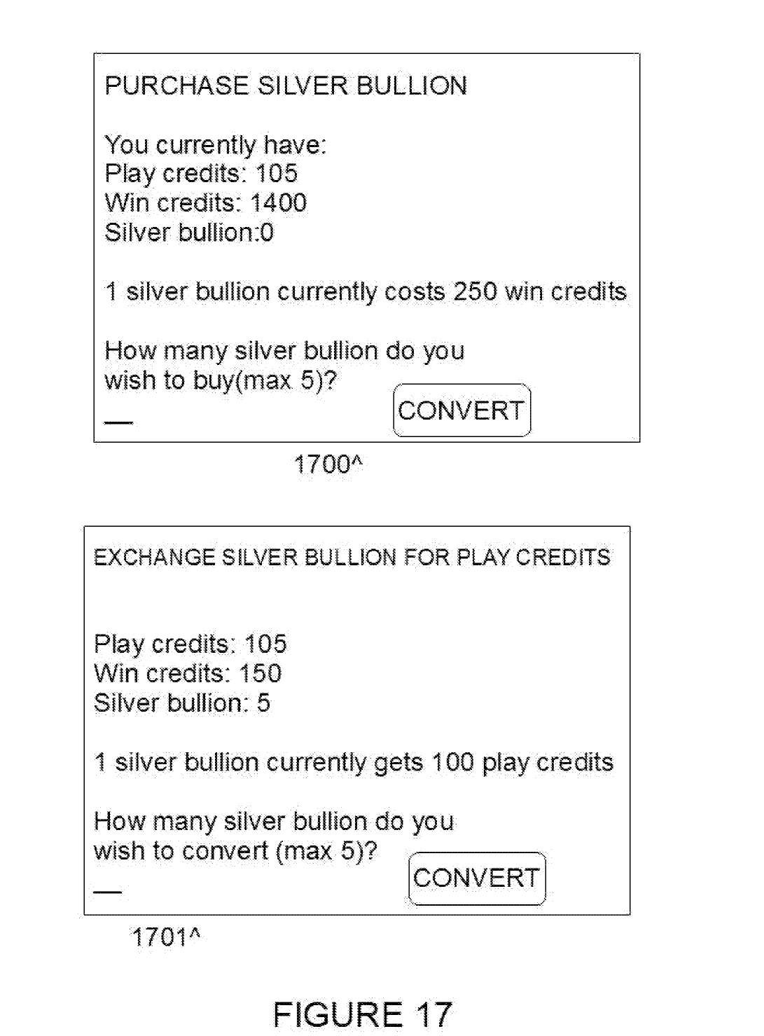

FIG. 17 is a drawing illustrate exchange screens, according to an embodiment.

A purchase silver screen 1700 is a screen used for operation 1608 which enables a player to select how many silver bullion (or other item) the player wishes to purchase. The player can select up to 5 bullion here since the player has 1400 win credits and 6 bullion would cost 1500 win credits which his more than the player currently has. The player can enter (using buttons, keyboard, etc.) how many silver bullion the player wishes to purchase and press the “convert” button. The player can also return to the slot game by pressing a cancel button (not pictured).

A sell silver screen 1701 is a screen used for operation 1609 when the player sells (exchanges) his/her silver bullion (or other commodity) for additional play credits. In this example, 1 silver bullion equals 100 play credits and the player currently has 5 silver bullion. If the player sells all 5 silver bullion, then the player would get 500 additional play credits (resulting in a total play credits of 605). The player can enter how many silver bullion the player wishes to sell (up to the 5 that the player has) and press the convert button to make the conversion. The player can also return to the slot game by pressing a cancel button (not pictured).

In one embodiment, when the player purchases silver bullion the player does not physically possess the silver bullion and the quantity of silver bullion represents how many silver bullion the player “has.” In another embodiment, if the player wants them, the player can pick up the silver bullion that the player has earned at a counter at the location where the player is playing. In an embodiment, if the player sells these silver bullion, then the player must return them back to the counter. In another embodiment,

Note that in operation 1608 and/or operation 1609, the price of the silver bullion can fluctuate and the price used in the calculations are based on the current market price for silver.

Note that while the player can always convert their win credits to silver bullion, the location where the gaming machine is present (e.g., internet café, etc.) would also have numerous other prizes as well that the player can exchange his/her win credits for (e.g., stuffed animals, shot glasses, footballs, etc.)

While silver bullion is used as an example here of a commodity that can be available for a prize in exchange for win credits and traded back to the house (system) in exchange for providing the player more play credits, it can be appreciated that other commodities can be used instead of silver bullion. Such as gold, copper, any commodity and in any form (coin, trinket, bar, etc.) Note that all silver bullion (or whatever object is being used) would be of equal value to each other.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All features described herein can be combined with any other features without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to play a game on an electronic machine, the method comprising:
receiving a token from a player in a coin slot;
responding to the receiving the token, crediting play credits on the machine;
enabling the player to play a slot game, the slot game comprising a) receiving play credits, spinning reels, and awarding win credits when the reels stop on winning combinations;
enabling the player to exchange win credits for objects of equal value; and
enabling the player to exchange the objects of equal value for play credits.

2. The method as recited in claim 1, wherein the objects are silver bullion.

3. The method as recited in claim 1, wherein a first exchange rate specifying how many win credits equals one of the objects is based on a current price of the object.

4. The method as recited in claim 1, wherein a second exchange rate specifying how many play credits equals one of the objects is based on a current price of the object.

5. The method as recited in claim 1, wherein the player physically receives the objects when exchanged for win credits.

6. The method as recited in claim 5, wherein the player gives up possession of the objects when exchanged for play credits.

7. The method as recited in claim 1, wherein the slot game has a plurality of paylines, and the play credits used to play the slot game are divided into separate wagers for each of the paylines.

8. The method as recited in claim 1, wherein win credits cannot directly be converted into play credits.

9. The method as recited in claim 1, wherein the token is a negotiable coin.

10. The method as recited in claim 1, further comprising, enabling the player to exchange the win credits for one of a plurality of different prizes.

11. A gaming machine system, comprising:
a coin slot;
a processing unit configured to read computer readable instructions stored on a storage medium, the computer readable instructions programmed to cause the processing unit to:
credit play credits when detecting a token inserted in the coin slot;
enable the player to play a slot game, the slot game comprising a) receiving play credits, spinning reels, and awarding win credits when the reels stop on winning combinations;
enable the player to exchange win credits for objects of equal value; and
enable the player to exchange the objects of equal value for play credits.

12. The apparatus as recited in claim 11, wherein the objects are silver bullion.

13. The apparatus as recited in claim 11, wherein a first exchange rate specifying how many win credits equals one of the objects is based on a current price of the object.

14. The apparatus as recited in claim 11, wherein a second exchange rate specifying how many play credits equals one of the objects is based on a current price of the object.

15. The apparatus as recited in claim 11, wherein the player physically receives the objects when exchanged for win credits.

16. The apparatus as recited in claim 15, wherein the player gives up possession of the objects when exchanged for play credits.

17. The apparatus as recited in claim 11, wherein the slot game has a plurality of paylines, and the play credits used to play the slot game are divided into separate wagers for each of the paylines.

18. The apparatus as recited in claim 11, wherein win credits cannot directly be converted into play credits.

19. The apparatus as recited in claim 11, wherein the token is a negotiable coin.

20. The apparatus as recited in claim 11, wherein the computer readable instructions are further programmed to enable the player to exchange the win credits for one of a plurality of different prizes.
